(19) United States
(12) Patent Application Publication
(10) Pub. No.: US 2008/0066137 A1
(43) Pub. Date: Mar. 13, 2008

(54) System and method of displaying system content

(75) Inventors: Ross Cox, Cumming, GA (US); Roland Noll, San Antonio, TX (US); Mary McCarthy, San Antonio, TX (US); Scott Pettit, San Antonio, TX (US); Christopher Lee, San Antonio, TX (US)

Correspondence Address: TOLER LAW GROUP, 8500 BLUFFSTONE COVE, SUITE A201, AUSTIN, TX, 78759, US

(73) Assignee: SBC Knowledge Ventures, LP, Reno, NV (US)

(21) Appl. No.: 11/510,851

(22) Filed: Aug. 25, 2006

(51) Int. Cl. H04N 7/173; G06F 13/00; H04N 5/45; H04N 7/16; H04N 5/445; G06F 3/00

(52) U.S. Cl. 725/135; 348/565; 725/37; 725/110; 725/114; 725/115

(57) ABSTRACT

The present disclosure is directed to a system and method of providing system information. The method can include sending system content to display concurrently with video content on a display device. The video content may be associated with a last selected channel of a set-top box prior to a trigger event.

### FIELD OF THE DISCLOSURE

The present disclosure relates generally to providing system content to a user of a television system.

### BACKGROUND

Television is a popular source of information and entertainment. Television systems may offer content that includes, for example, television programming, video-on-demand, local weather, and music, for example, on separate channels. The content provided by a television system is associated with a channel that may be selected by a viewer of the television system. A viewer may change channels to change the content received on a television set, typically with a remote control.

### BRIEF DESCRIPTION OF THE DRAWINGS

FIG. 1 is a block diagram illustrating an embodiment of an Internet Protocol Television (IPTV) system;

FIG. 2 is a block diagram illustrating an embodiment of a system having a set-top box;

FIG. 3 is a flow diagram illustrating an embodiment of a method of providing system information;

FIG. 4 is a flow diagram illustrating an embodiment of a method of providing system information;

FIG. 5 is an illustration depicting an embodiment of an interface;

FIG. 6 is a diagram of an embodiment of a general computer system.

### DETAILED DESCRIPTION OF THE DRAWINGS

In one embodiment, a method of providing system information to a user of a television system is disclosed. The method includes determining video content associated with a last selected channel of a set-top box prior to a trigger event, retrieving first system content from a first source of the television system, and sending the first system content to display concurrently with the video content on a display device.

In another embodiment, a set-top box device is disclosed. The set-top box device includes a memory device accessible to a processor, a network interface, and a display interface to communicate with a display device. The set-top box device also includes a buffer to receive video content from a first source via the network interface. The set-top box includes a trigger event module to determine a soft portal trigger event and a content acquisition module to retrieve video content associated with a last channel selected by the set-top box prior to the trigger event from a first content source and to retrieve system content from a second content source. The set-top box device also includes a soft portal module to display the video content in a first viewing region at the display device and to concurrently display the system content in a second viewing region at the display device.

In another embodiment, an interface is disclosed. The interface includes a first viewing region to display video content associated with a television channel received from a first source of a television system. The interface also includes a second viewing region to display information received from a second source of the television system. The first viewing region and the second viewing region are displayed on a display device communicating with a set-top box. The television channel is a last television channel selected by a user of the display device prior to a trigger event.

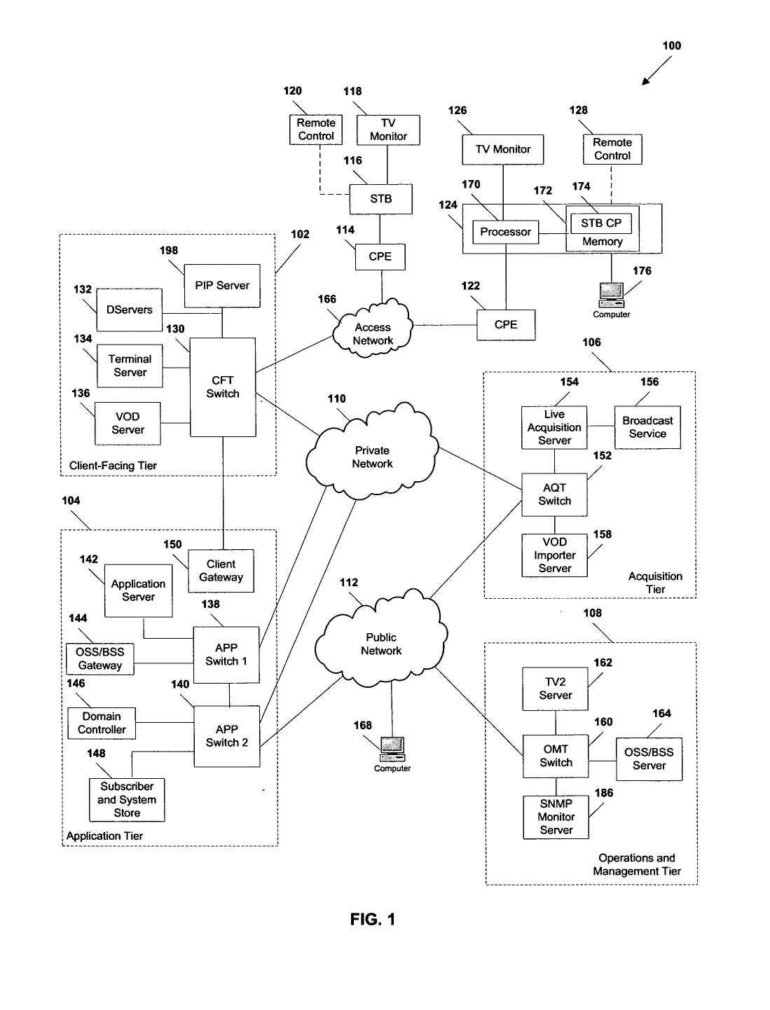

Referring to FIG. 1, an illustrative embodiment of an Internet Protocol Television (IPTV) system that may be used to share private content is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 at a first customer premise via the first CPE 114 and with a second representative set-top box device 124 at a second customer premise via the second CPE 122. The CPE 114, 122 can include routers, local area network devices, modems, such as digital subscriber line (DSL) modems, any other suitable devices for facilitating communication between a set-top box device and the access network 166, or any combination thereof.

In a particular embodiment, the client-facing tier 102 can be coupled to the CPE 114, 122 via fiber optic cables. Alternatively, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a set-top box (STB) processor 170 and a STB memory device 172 that is accessible to the STB processor 170. In one embodiment, a computer program, such as the STB computer program 174, can be embedded within the STB memory device 172. In another illustrative embodiment, a user computing device 184, such as a personal computer, laptop or local server, can be coupled to a set-top box device, such as the second representative set-top box device 124, for example, via a universal serial bus (USB) connection or other connection.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a connection point to the private network 110. In a particular embodiment, the CFT switch 130 can be coupled to a video-on-demand (VOD) server 136 that stores or provides VOD content imported by the IPTV system 100. The CFT switch can also be coupled to a picture-in-picture (PIP) server 198 that provides picture-in-picture video content for communication from the client-facing tier 102 to the set-top box devices 116, 124.

In an illustrative embodiment, the client-facing tier 102 can communicate with a large number of set-top boxes, such as the representative set-top boxes 116, 124 over a wide geographic area, such as a regional area, a metropolitan area, a viewing area, a designated market area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that feeds one or more video streams from a video server to multiple set-top box devices.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses of corresponding set-top box devices 116, 124.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication to the set-top box devices 116, 124. The CFT switch 130 can receive content and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer (PC) 168 coupled to the public network 112.

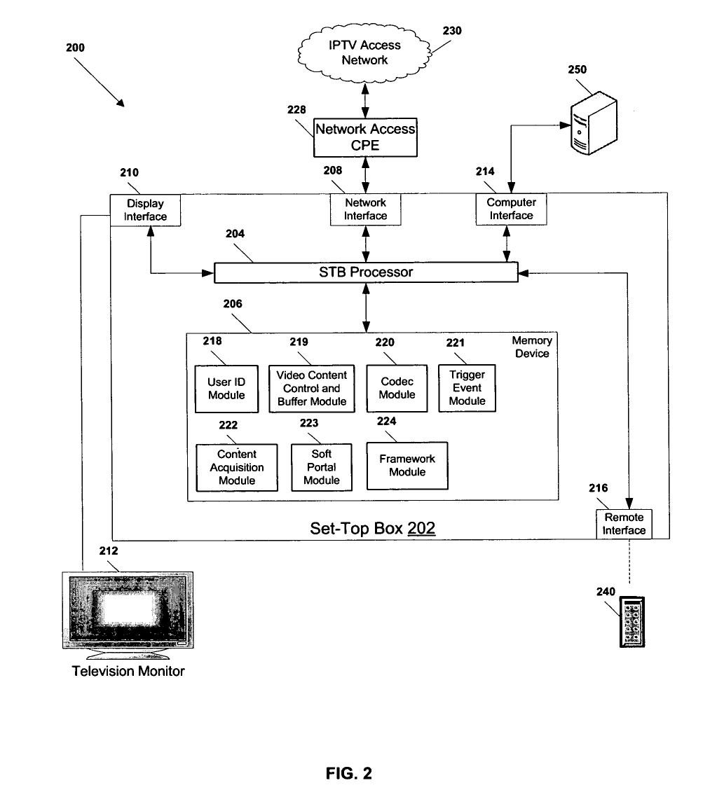

Referring to FIG. 2, an embodiment of a system is depicted and generally designated 200. The system 200 includes a set-top box 202 coupled to a content source, such as an IPTV access network 230, via a network access customer premises equipment (CPE) 228. The set-top box 202 includes a memory device 206 accessible to a processor 204. The set-top box 202 also includes a display interface 210 to communicate with a display device 212, such as a television monitor. The set-top box 202 includes a network interface 208 to communicate with the content source, such as the IPTV access network 230 via the network access CPE 228. The set-top box 202 may also include a computer interface 214 to communicate with a computer 250, and a remote control interface 216 for wireless communication with a remote control device 240.

In a particular illustrative embodiment, the set-top box 202 may include a video content control and buffer module 219 to receive video content from a first source via the network interface 208. The first source may be an IPTV system.

The set-top box 202 may include a trigger event module 221 to determine a soft portal trigger event. The soft portal trigger event may include a period of inactivity of a user of the set-top box 202. As an illustrative example, the period of inactivity may include a period of a predetermined duration where the set-top box does not receive any commands from a remote control device 240. As another illustrative example, the soft portal trigger event may be a powering on of the set-top box 202. As another illustrative embodiment, the soft portal trigger event may be a powering on of the display device 212.

The set-top box 202 may include a content acquisition module 222 to retrieve video content associated with the last channel selected by the set-top box 202 prior to the trigger event. The video content that is retrieved that is associated with the last channel selected by the set-top box 202 may be retrieved from a first content source. As an illustrative example, the first content source may be a PIP source, such as the PIP server 198 of the IPTV system 100 of FIG. 1. The content acquisition module 222 may also retrieve system content from a second content source. As another illustrative example, the second content source may a VOD source, such as the VOD server 136 of the IPTV system 100. A soft portal module 223 may display the video content in a first viewing region at the display device 212. The soft portal module 223 may also concurrently display the system content in a second viewing region at the display device 212.

In a particular illustrative embodiment, the first viewing region and the second viewing region may be defined by a framework module 224 that may be accessible to the soft portal module 223. The framework module 224 may be received at the set-top box 202 and stored in the memory device 206. In an embodiment, the framework module 224 may be pushed to the set-top box 202 from an application server, such as the application server 142 of FIG. 1.

In a particular illustrative embodiment, a subscriber store, such as the system and subscriber store 148 of the IPTV system 100 of FIG. 1, may maintain a list of channels requested by the set-top box 202. The content acquisition module 222 may therefore retrieve an identification of the last channel selected by the set-top box 202 prior to the trigger event from the subscriber store. Thus, information relating to a last selected channel of the set-top box 202 may be obtained via the IPTV access network 230 and need not be stored at the set-top box 202.

The content acquisition module 222 may retrieve the system content from a data store of an IPTV system as extensible markup language (XML) data. In an illustrative example, a data store of the IPTV system may be the subscriber and system store 148 of the IPTV system 100 depicted in FIG. 1. In another illustrative example, a source of system content may be a terminal server, such the terminal server 134 of the IPTV system 100. As another illustrative example, a source of system content may be a VOD server, such as the VOD server 136 of the IPTV system 100.

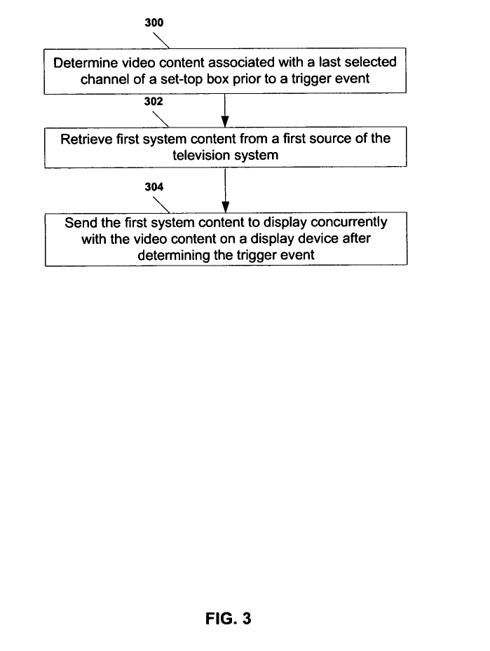

Referring to FIG. 3, a particular illustrative embodiment of a method of providing system information to a user of a television system is depicted. The method begins at 300 with determining video content associated with a last selected channel of a set-top box prior to a trigger event. The method continues at 302, where first system content is retrieved from a first source of the television system. The method continues at 304, with sending the first system content to display concurrently with the video content on a display device after determining the trigger event. Thus, system information may be displayed to a user while continuing to provide video content from the last selected channel. For example, a television user may select channel 8 and then turn the television off. When the user turns the television back on, channel 8 is determined to be the last selected channel before the powering up of the television. System information and channel 8 programming may therefore be displayed concurrently at the television.

Retrieving the first system content may include sending a request for content associated with a first television channel to the television system. The first television channel may be a channel other than the last selected channel. For example, the last selected channel may be a sports channel, while the first television channel with which the first system content is associated may relate to a video-on-demand (VOD) server request tracking application.

In an embodiment, determining the video content at 300 includes sending a request for the video content from a picture-in-picture content source of the television system. For example, the video content associated with the last selected channel of the set-top box may be requested to be displayed from a picture-in-picture server, such as the PIP server 198 of the IPTV system 100, as depicted in FIG. 1.

In an embodiment, the trigger event may include a period of inactivity of the set-top box. For example, the period of inactivity may be a predetermined duration of inactivity at the remote control interface of the set-top box. In a particular embodiment, the trigger event may be determined by the set-top box. In other embodiments, the trigger event may be determined by the television system, or by either of the television system, the set-top box, or by any combination thereof.

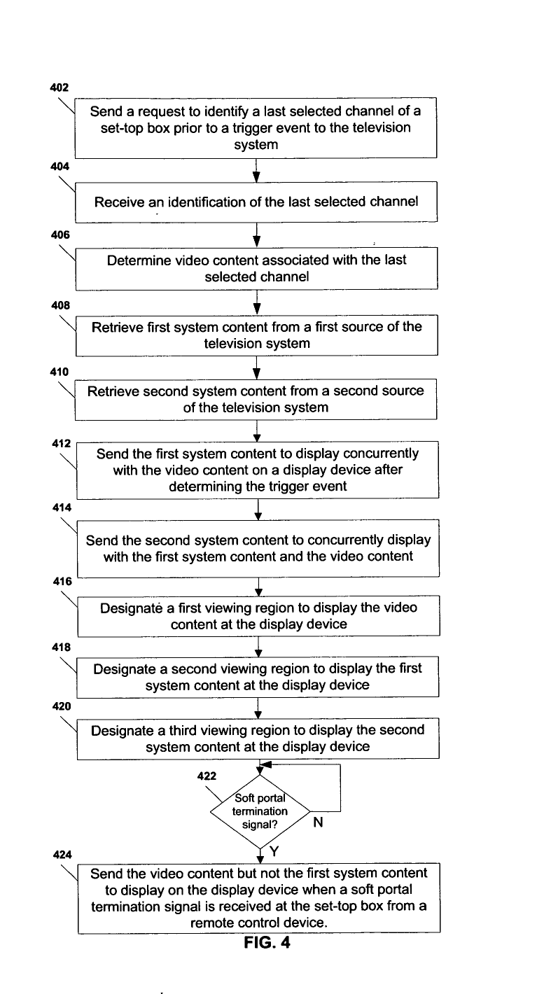

Referring to FIG. 4, a method of providing system information to a user of a television system is depicted. The method begins at 402, with sending a request to identify a last selected channel of a set-top box prior to a trigger event to the television system. The method continues at 404, with receiving an identification of the last selected channel. At 406, video content associated with the last selected channel is determined. First system content is retrieved from a first source of the television system at 408, and second system content is retrieved from a second source of the television system at 410.

For example, a set-top box (STB) may determine that it has been powered up after being turned off, and send a request to identify the last channel selected before the STB was powered up. The STB may receive a response indicating channel 8 was the last selected channel, and request channel 8 programming to display. The STB may also retrieve from the television system local weather information from a source of weather information and an advertisement from a source of advertisements.

The first system content is sent to display concurrently with the video content on a display device after determining the trigger event at 412. At 414, the second system content is sent to display concurrently with the first system content and the video content. At 416, a first viewing region is designated to display the video content at the display device. A second viewing region is designated to display the first system content at the display device at 418, and a third viewing region is designated to display the second system content at the display device at 420. For example, the video content may be displayed in the upper-right quarter of the display device, local weather information in the upper left quarter, and an advertisement across the bottom half of the display device.

At 422, a receipt of a soft portal termination signal at the set-top box from a remote control device is evaluated. When the soft portal termination signal has been received, the method continues at 424 with sending the video content, but not the first system content and not the second system content, to display on the display device. For example, when a user presses the exit button on a remote control, the system information may disappear-from the screen, leaving only the video content for traditional, full screen viewing.

If the soft portal termination signal is not received at 422, processing returns to the evaluation at 422. As non-limiting, illustrative examples, a soft portal termination signal may include a signal generated by the pressing of a remote control key, such as exit, channel up, channel down, arrow keys, number keys, menu, guide, search, video on demand, “i” (go interactive), clear, info, my recordings, record, mute, and last.

In an embodiment, the television system includes at least three sources of system content from which the first source and the second source may be determined in accordance with a selection algorithm. For example, the first source and the second source may be selected by a reference to a database of the IPTV system, or a table of the set-top box. As another example, the first content and the second content may be retrieved from the sources of system content according to a predetermined pattern, after a predetermined length of time of displaying the content. For example, the first source may be a VOD server, displaying VOD statistics for a designated time, followed by a local weather and traffic report from another source of the IPTV system for a second designated period of time.

In an embodiment, the first system content includes at least one of a ranking of video-on-demand program popularity, a hint corresponding to a use of the television system, and information corresponding to a digital video recorder status. For example, a list of the top ten video-on-demand programs for the day may be displayed as the first system content. As another example, a randomly selected helpful hint on how to use features of the television system may be displayed. As yet another example, information corresponding to the last television program recorded on a digital video recorder (DVR) and the next television program scheduled to record at the DVR may be displayed as the first system content.

In an embodiment, the second system content may include at least one of local system messages, national service messages, current date, current time, local weather, and an advertisement. As illustrative, non-limiting examples, a local system message may include VHO messages, changes, programming announcements, or specials. As illustrative, non-limiting examples, a national service message may include general announcements, lineup changes, programming announcements, or specials. Advertisements may be provided as text, pictures, animated pictures such as Flash or animated GIF, or the like, or any combination thereof.

The video content displayed at the display device may be responsive to at least one of a fast forward, pause, and rewind command received at the set-top box from a remote control device. Thus, a user may control the video content displayed alongside the system content via typical remote control commands. Therefore, the video content may be controlled by a user without interfering with the display of system content on the soft portal screen.

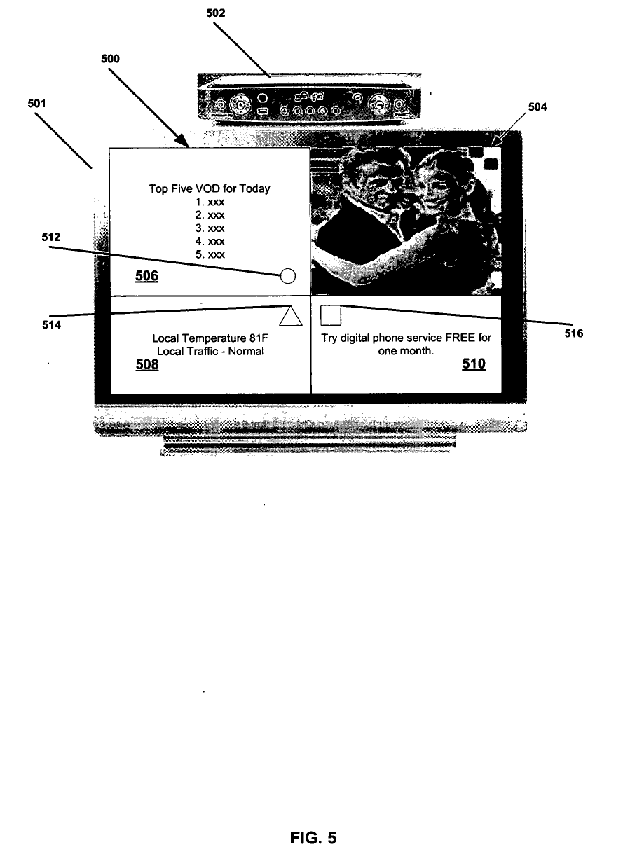

Referring to FIG. 5, an embodiment of a user interface is depicted and generally designated 500. The user interface 500 may be displayed on a display device 501 that is coupled to a set-top box 502. The user interface may include a first viewing region 504 to display video content associated with a television channel received from a first source of a television system. The video content displayed on the first viewing region 504 may be associated with the last television channel selected by the user of the display device 501 prior to a trigger event. The user interface 500 may also include a second viewing region 506 to display information received from a second source of the television system.

The second viewing region 506 may also display a first hot key indicator 512. In an embodiment, a third viewing region 508 may display information received from a third source of the television system and may also display a second hot key indicator 514. In an embodiment, a fourth display region 510 may display information received from a fourth source of the television system and may also display a third hot key indicator 516.

In an embodiment, the interface 500 displays a hot key indicator 512, 514, 516 corresponding to a button of a remote control device (not shown). For example, the first hot key button 512 may be depicted as a round indicator and may correspond to a round button of the remote control device. Similarly, the second hot key indicator 514 may be depicted as a triangle and may correspond to a triangular button of the remote control device. Also, the third hot key indicator 516 may be depicted as a square and may correspond to a square button of the remote control device. It should be understood that the hot key indicators 512, 514, 516 need not be depicted as shapes, and may instead be-depicted as letters, numbers, colors, icons, or the like, or any combination thereof.

In an embodiment, a user selection of a hot key of the remote control device may result in a response of the set-top box 502 that is determined by hot key data from the source of the television system providing the content for the viewing region 506, 508, 510 that displays the corresponding hot key indicator 512, 514, 516. Thus, for example, the source of data providing system content for the second viewing region 506 may provide hot key data corresponding to the first hot key indicator 512. Similarly, the source of the television system providing information for the third viewing region 508 may also provide hot key data for the second hot key indicator 514. Also, the source of the television system providing information for the fourth viewing region 510 may also provide hot key data corresponding to the third hot key indicator 516.

In an embodiment, the hot key data that is received from the source of the television system includes an identification of a television channel associated with the information received from the source of the television system. A response of the set-top box 502 to a user selection of the hot key may include requesting content associated with the television channel identified by the hot key data. For example, a user selection of a circular hot key corresponding to the first hot key indicator 512 may cause the set-top box 502 to request content associated with a ranking of video-on-demand programs, corresponding to information displayed in the second viewing region 506.

In an embodiment, the trigger event may include a powering up of the set-top box 502. In another embodiment, the trigger event may include a powering up of the display device 501. In another embodiment, the trigger event may include a predetermined period of inactivity of the set-top box 502. In another embodiment, the trigger event may include a combination of a powering up of the set-top box 502, a powering up of the display device 501, and a period of inactivity.

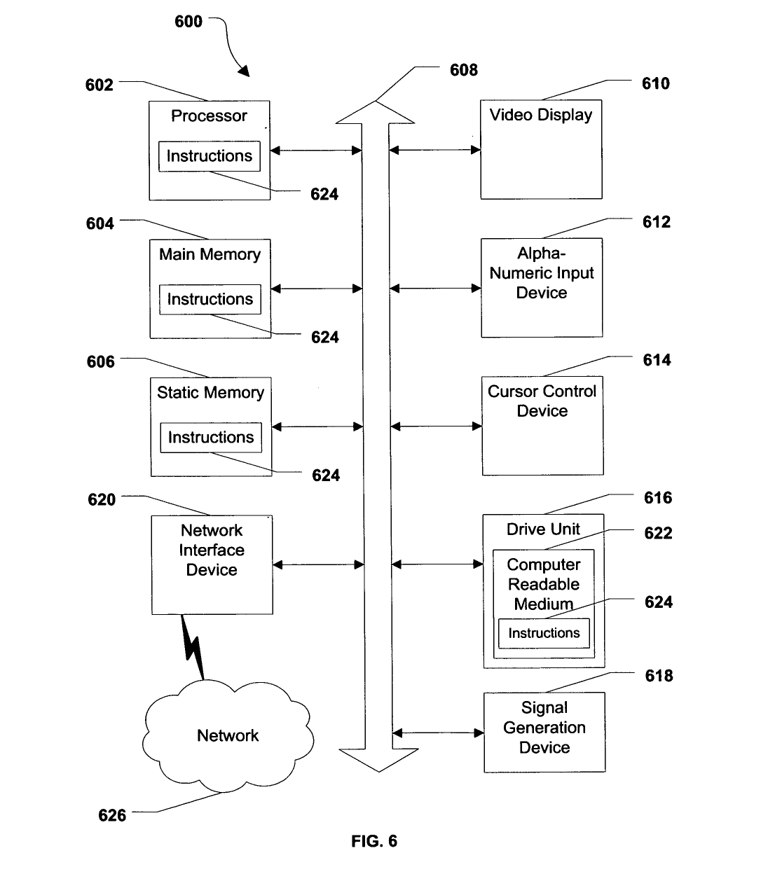

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600, or any portion thereof, may operate as a standalone device, such as the set-top box devices and domain controller shown in FIG. 1, or may be connected, e.g., using a public network or a private network within an IPTV system, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. Further, the computer system 600 can include a wireless input device 615, e.g., a remote control device. When the computer system 600, or any portion thereof, is embodied in a set-top box device, the cursor control device 614 can be a remote control device. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In conjunction with the configuration of structure described herein, the system and method disclosed may send video content and system content to display at a display device. The video content may be associated with a last selected channel of a set-top box prior to a trigger event. The system data and the video data may be received from different sources of a television system.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing system information to a user of a television system, comprising:
determining video content associated with a last selected channel of a set-top box prior to a trigger event;
retrieving first system content from a first source of the television system; and
sending the first system content to display concurrently with the video content on a display device after determining the trigger event.

2. The method of claim 1, wherein retrieving the first system content includes sending a request for content associated with a first television channel to the television system.

3. The method of claim 2, wherein the first television channel is other than the last selected channel.

4. The method of claim 1, wherein determining the video content includes sending a request for the video content from a picture-in-picture content source of the television system.

5. The method of claim 1, wherein the trigger event comprises a period of inactivity of the set-top box.

6. The method of claim 5, wherein the trigger event is determined by the set-top box.

7. The method of claim 1, further comprising:
sending a request to identify the last selected channel to the television system; and
receiving an identification of the last selected channel.

8. The method of claim 1, further comprising:
retrieving second system content from a second source of the television system;
sending the second system content to concurrently display with the first system content and the video content;
designating a first viewing region to display the video content at the display device;
designating a second viewing region to display the first system content at the display device; and
designating a third viewing region to display the second system content at the display device.

9. The method of claim 8, wherein the television system comprises at least three sources of system content, and wherein the first source and the second source are determined from the at least three sources of system content in accordance with a selection algorithm.

10. The method of claim 1, wherein the first system content comprises at least one of a ranking of on-demand program popularity, a hint corresponding to a use of the television system, and information corresponding to a digital video recorder status.

11. The method of claim 10, wherein the second system content comprises at least one of local system messages, national service messages, current date, current time, local weather, and an advertisement.

12. The method of claim 1, further comprising sending the video content but not the first system content to display on the display device when a soft portal termination signal is received at the set-top box from a remote control device.

13. The method of claim 1, wherein the video content is displayed at the display device responsive to at least one of a fast forward, pause, and rewind command received at the set-top box from a remote control device.

14. A set top-box device, comprising:
a memory device accessible to a processor;
a network interface;
a display interface to communicate with a display device;
a buffer to receive video content from a first source via the network interface;
a trigger event module to determine a soft portal trigger event;
a content acquisition module to retrieve video content associated with a last channel selected by the set-top box prior to the trigger event from a first content source and to retrieve system content from a second content source;
a soft portal module to display the video content in a first viewing region at the display device and to concurrently display the system content in a second viewing region at the display device.

15. The device of claim 14, wherein a framework module accessible to the soft portal module defines the first viewing region and the second viewing region.

16. The device of claim 15, wherein the framework module is received at the set-top box, and wherein the framework module is stored in the memory device of the set-top box.

17. The device of claim 16, wherein the soft portal trigger event comprises a period of inactivity of a user of the set-top box.

18. The device of claim 14, wherein the first source is an internet protocol television (IPTV) system.

19. The device of claim 18, wherein a subscriber store of the IPTV system maintains a list of channels selected by the set-top box, and wherein the content acquisition module is further operable to retrieve an identification of the last channel selected by the set-top box prior to the trigger event from the subscriber store.

20. The device of claim 18, wherein second content source is a data store of the IPTV system, and wherein the system content is retrieved as extensible markup language (XML) data.

21. An interface, comprising:
a first viewing region to display video content associated with a television channel received from a first source of a television system; and
a second viewing region to display information received from a second source of the television system;
wherein the first viewing region and the second viewing region are displayed on a display device communicating with a set-top box; and
wherein the television channel is a last television channel selected by a user of the display device prior to a trigger event.

22. The interface of claim 21, wherein the second viewing region further displays a hotkey indicator corresponding to a button of a remote control device, and wherein hotkey data from the second source of the television system determines a response of the set-top box to receiving a signal indicating a selection of the hotkey from the remote control device.

23. The interface of claim 22, wherein the hotkey data comprises an identification of a television channel associated with the information received from the second source of the television system, and wherein the response of the set-top box includes requesting content associated with the television channel identified by the hotkey data.

24. The interface of claim 21, wherein the trigger event is at least one of a powering up of the set top box, a powering up of the display device, and a predetermined period of inactivity of the set top box.
